(19) United States
(12) Patent Application Publication
(10) Pub. No.: US 2008/0105330 A1
(43) Pub. Date: May 8, 2008

(54) STORAGE DEVICE CAPABLE OF DETECTING LIQUID LEVEL

(76) Inventor: Wei-Jui Chuang, Kaohsiung (TW)

Correspondence Address: G. LINK CO., LTD., 3550 BELL ROAD, MINOOKA, IL, 60447, US

(21) Appl. No.: 11/556,588

(22) Filed: Nov. 3, 2006

(51) Int. Cl. B65B 1/30; F16K 21/00

(52) U.S. Cl. 141/198; 137/386

(57) ABSTRACT

A storage device capable of detecting liquid level for liquid fuel required by a fuel cell includes a main storage tank, a measurement pipe and a liquid level detection device. The main storage tank is employed to receive the liquid fuel. The measurement pipe is independent from the main storage tank and communicates with the main storage tank via a tube section. The liquid level detection device is attached to the measurement to measure level of the liquid fuel.

### BACKGROUND OF THE INVENTION

1. Field of the Invention

The present invention is related to a storage device and particularly to a storage device capable of detecting liquid level for maintaining sufficient amount of liquid fuel required by a fuel cell.

2. Brief Description of the Related Art

It is known that a fuel cell is a power generating device to convert chemical energy in a fuel and oxide agent to electrical energy directly by means of electrical pole reaction. Currently, there are a lot of different types of fuel cells and they can be classified based on different electrolytes as basic fuel cell, phosphoric acid fuel cell, proton exchange film fuel cell, molten carbonic acid fuel cell and solid state oxide fuel cell. Wherein, the proton exchange film fuel cell further includes direct methanol fuel cell. The direct methanol fuel cell uses methanol as the fuel directly instead of being changed to hydrogen in advance. This is one of high capacity technologies has been developed and researched at the present time and it is mostly applied to large scale power plant, power generator for cars and portable power source.

However, the liquid fuel cell such as the direct methanol fuel cell encounters a problem in the process of stepping into a commercialized product and the problem is how to steadily output the power. In order to maintain steady power output, sufficient amount of the liquid fuel in a fuel supply device has to be kept in a reasonable range. Otherwise, the liquid fuel cell is incapable of supplying power constantly in case of being short of liquid fuel. Thus, a liquid level detection device plays an important role to trace amount of the liquid fuel cell in the fuel cell storage device, that is, level of the liquid fuel in the storage device has to be detected constantly to ensure the level in a preset standard range. In this way, quality of power supply of the fuel cell can be maintained and an electronic product attached to the fuel cell can be free from damage due unsteady power supply of the fuel cell.

### SUMMARY OF THE INVENTION

Accordingly, an object of the present invention is to provide a storage device capable of detecting liquid level with which the liquid fuel required by the fuel cell fuel cell can be traced constantly such that a prompt response is able to be taken while it is short of the liquid fuel.

In order to achieve the preceding object, a storage device capable of detecting liquid level for maintaining sufficient amount of liquid fuel required by a fuel cell according to the present invention includes a main storage tank, a measurement pipe and a liquid level detection device. The main storage tank is employed to receive the liquid fuel. The measurement pipe is independent of the main storage tank and communicates with the main storage tank via a tube section. The liquid level detection device is attached to the measurement to measure level of the liquid fuel.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a sectional view illustrating internal structure of a first preferred embodiment of a storage device capable of detecting liquid level according to the present invention;

FIG. 2A is a fragmentary perspective view of a second preferred embodiment of a storage device capable of detecting liquid level according to the present invention; and

FIG. 2B is a sectional view of the storage device capable of detecting liquid level shown in FIG. 2A.

### DETAILED DESCRIPTION OF THE INVENTION

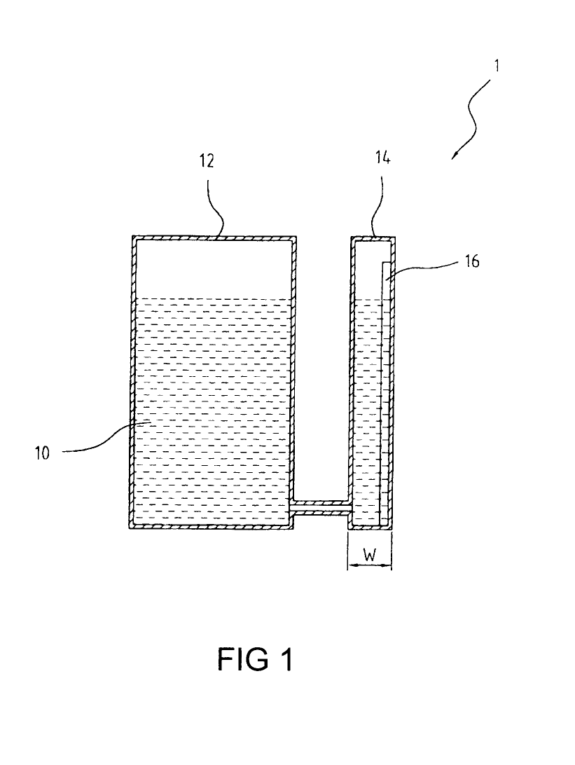

Referring to FIG. 1, a fuel storage device 1 of the first embodiment according to the present invention is employed to store liquid fuel required by a fuel cell. If the fuel storage device 1 is used in a direct methanol fuel cell device, liquid fuel 10 received in the fuel storage device 1 is highly concentrated pure methanol solution or thinned methanol solution.

It is shown in FIG. 1 that the storage device 1 includes a main storage tank 12, a measurement pipe 14 and a liquid detecting device 16. The main storage tank 12 is employed to contain the liquid fuel 10 so that the main storage tank 12 can be a conventional high concentrated liquid fuel tank or mixing tank. The main storage tank 12 communicates with the measurement pipe 14 with a tube section. In order to provide a compact size, it is preferable that the measurement pipe 14 is arranged to have a small volume with a diameter W between 0.5 mm and 4 mm. Further, the liquid detection device 16 is mounted to the measurement pipe 14 to measure liquid level of the liquid fuel 10 in the fuel storage device 1. The liquid detection device 16 can be an electronic level gage, a buoy or any other level instrument. The liquid detection device 16 is arranged in the measurement pipe 14 or at the outer side of the measurement pipe 14 in a way of being attached to the wall surface of the measurement pipe 14 without touching the fuel for sensing liquid level of the fuel. In case of the electronic level gage being used, it can be implemented that the electronic level gage keeps measuring and recording the level of the liquid fuel 10 constantly by means of air pressure, water pressure, a buoyant ball or supersonic wave. Besides, the liquid fuel 10 normally is highly corrosive and acidic so that the surface of the liquid detection device 16 is treated with anti-corrosion and/or anti-acid in case of the liquid detection device 16 being disposed in the measurement pipe 14.

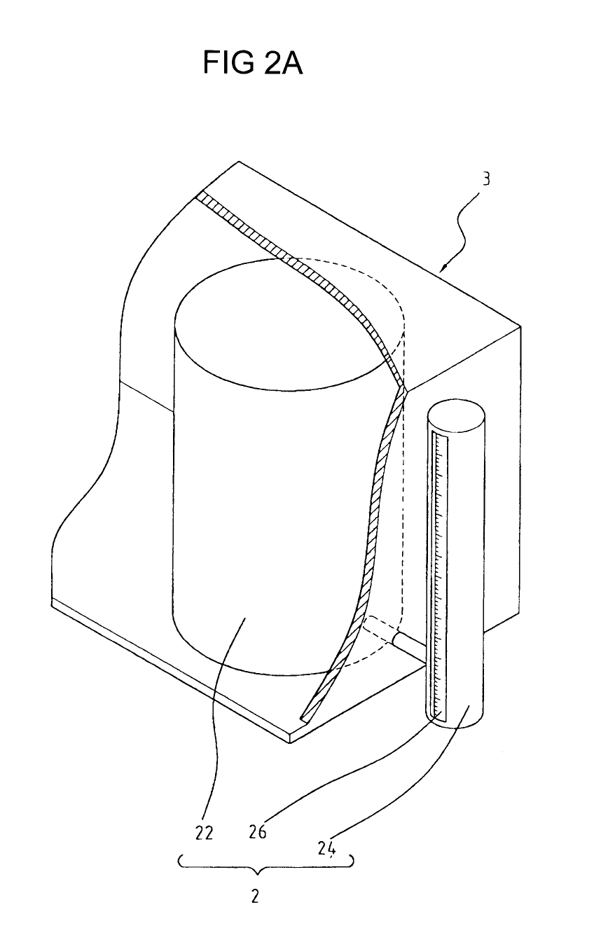

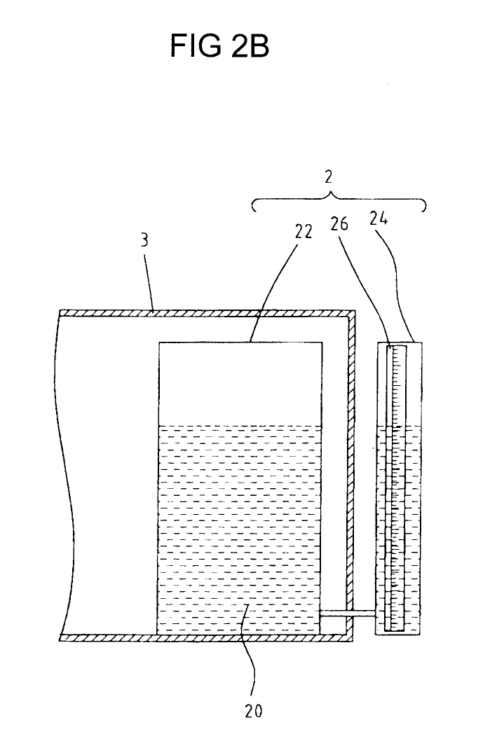

Referring to FIGS. 2A and 2B, the second preferred embodiment of the storage device according to the present invention is illustrated. It can be seen in FIG. 2B that the fuel storage device 2 includes a main storage tank 22, a measurement pipe 24 and a liquid detecting device 26. The main storage tank 22 is employed to contain the liquid fuel 20 and communicates with the measurement pipe 24 with a tube section. The measurement pipe 24 is independent of the main storage tank 22. The liquid detection device 26 is mounted to the measurement pipe 24 to measure level of the liquid fuel 20 in the fuel storage device 2. The liquid detection device 26 is implemented to be a scale on the inner wall surface of the measurement pipe 24 as shown in FIG. 2A. The main storage tank 22 is received in the fuel cell device 3 and the measurement pipe 24 is disposed outward the fuel cell device 3. Hence, the level of the liquid fuel 20 in the main storage tank 22 can be read out with sighting the scale on the measurement pipe 24.

It is appreciated that the measurement pipe 14, 24 with liquid detection device 16, 26 is capable of allowing the user to check the fuel left in the main storage tank 12, 22. In this way, the problem concerning the main storage tank 12, 22 being unable to be attached with a liquid detection device can be solved in addition to the amount of the liquid left in the main storage tank 12. 22 keeping be acknowledged. This is the advantage of the storage device capable of detecting liquid level according to the present invention.

While the invention has been described with referencing to preferred embodiments thereof, it is to be understood that modifications or variations may be easily made without departing from the spirit of this invention, which is defined by the appended claims.

What is claimed is:

1. A storage device capable of detecting liquid level for liquid fuel required by a fuel cell, comprising:
a main storage tank, being employed to receive the liquid fuel;
a measurement pipe, being independent of the main storage tank and communicating with the main storage tank via a tube section; and
a liquid level detection device, being attached to the measurement to measure level of the liquid fuel.

2. The storage device capable of detecting liquid level as defined in claim 1, wherein the liquid level detection device is an electronic level gage.

3. The storage device capable of detecting liquid level as defined in claim 1, wherein the liquid level detection device is a scale disposed on a wall surface of the measurement pipe.

4. The storage device capable of detecting liquid level as defined in claim 1, wherein the liquid fuel is methanol solution.

5. The storage device capable of detecting liquid level as defined in claim 1, wherein liquid fuel is pure methanol solution.

6. The storage device capable of detecting liquid level as defined in claim 1, wherein the measurement pipe has a diameter between 0.5 mm to 4 mm.

7. The storage device capable of detecting liquid level as defined in claim 1, wherein the liquid detection device is disposed in the measurement pipe and treated with anti-corrosion and/or anti-acid.

8. The storage device capable of detecting liquid level as defined in claim 1, wherein the fuel cell is a direct methanol fuel cell.
